(19) United States
(12) Patent Application Publication
(10) Pub. No.: US 2022/0266963 A1
(43) Pub. Date: Aug. 25, 2022

(54) SYSTEM AND METHOD FOR HULL CLEANING

(71) Applicant: Offshore Designs Ltd., Mill Bay (CA)

(72) Inventors: Voytek Roman KLAPTOCZ, Mill Bay (CA); George William RAWLINGS, Vancouver (CA)

(21) Appl. No.: 17/630,836

(22) PCT Filed: Aug. 4, 2020
(86) PCT No.: PCT/CA2020/051064

§ 371 Date: Jan. 27, 2022

Related U.S. Application Data
(60) Provisional application No. 62/883,462, filed on Aug. 6, 2019.

(51) Int. Cl. B63B 59/08; B08B 3/02; B08B 13/00

(52) U.S. Cl. CPC B63B 59/08; B08B 3/024; B08B 13/00; B63B 2059/087; B08B 2203/027

(57) ABSTRACT

A system for cleaning a hull of a vessel includes a cleaning head configured to contact the hull of the vessel and to move relative to the hull. The cleaning head includes cleaning elements for removing at least a portion of biofouling on the hull, a cable connected to the cleaning head and coupled to a winch for connecting the cleaning head to the vessel, a pulley system that includes a sheave disposed near the bow and between the cleaning head and the winch and through which the cable is routed, and a control system in communication with the cleaning head.

### FIELD OF THE INVENTION

The present invention relates to systems and methods for hull cleaning.

### BACKGROUND

In-water cleaning of a vessel may be utilized to at least partially remove biofouling from the surface of the vessel's hull, as well as from other areas such as bow thrusters, rudders, shafts, sea-chests, bilge keels, and/or propellers. In the present description, biofouling refers to an accumulation of microorganisms, plants, algae, or other biological material on a wetted or underwater surface.

The vessel may be a ship. Alternatively, the vessel may be a yacht, a submersible, or a barge, for example. In-water cleaning can be performed between dry-docking cycles, for example.

It is advantageous to remove biofouling of a vessel because even a small layer of slime can increase the vessel's hydrodynamic resistance. Such an increase in resistance may result in a corresponding increase in fuel cost of hundreds of thousands of dollars annually for commercial ocean-going vessels, for example. Biofouling may also be removed in order to at least reduce the spread of an invasive species from port to port.

Hull cleaning is typically performed when a vessel is stationary. The cleaning is done when the vessel is in harbour, for example while moored at a dock, or when at anchor.

In-water hull cleaning may be performed either by divers, or by robotic systems that are controlled remotely or automated.

### SUMMARY

According to an aspect of an embodiment, a system for cleaning a hull of a vessel is provided. The system includes a cleaning head configured to contact the hull of the vessel and to move relative to the hull, the cleaning head including cleaning elements for removing at least a portion of biofouling on the hull, a cable connected to the cleaning head and coupled to a winch for connecting the cleaning head to the vessel, a pulley system that includes a sheave disposed near the bow and between the cleaning head and the winch and through which the cable is routed, and a control system in communication with the cleaning head.

The cable may mechanically couple the cleaning head to the winch and electrically couple the cleaning head to the control system.

The cleaning elements may include one or more of cavitating waterjets, waterjets, wipers, and brushes.

The winch may be coupled to the deck of the vessel and may be coupled to the control system to control the length of cable that is paid out.

The pulley may include a sheave disposed near a bow of the vessel and above the waterline of the vessel.

The control system controls movement of the cleaning head relative to the hull and may control a pump coupled to the cable to control a supply of water to the cleaning head.

Cameras onboard the cleaning head may be utilized for capturing live video and the control system may record the live video as well as data from instrumentation utilized for hull inspection.

The cleaning head may include software and hardware to control the movement of the cleaning head relative to the hull, for example, in an autopilot mode.

The cleaning head may include one or more wheels or tracks coupled to a motor for moving the cleaning head relative to the hull or may include a thruster.

Magnets may couple the cleaning head to the hull or a pump may be utilized to create suction against the hull to maintain contact of the cleaning head with the hull.

According to another aspect of an embodiment, there is provided the use of a system for cleaning a hull of a vessel while the vessel is underway. The system includes a cleaning head configured to contact the hull of the vessel and to move relative to the hull, the cleaning head including cleaning elements for removing at least a portion of biofouling on the hull, a cable connected to the cleaning head and coupled to a winch for connecting the cleaning head to the vessel, a pulley system including sheave assembly disposed at or near the bow and through which the cable is routed, from the cleaning head, through the pulley system, and to the winch, and a control system in communication with the cleaning head.

According to still another aspect of an embodiment a method is provided for cleaning a hull of a vessel utilizing a cleaning system. The system includes a cleaning head configured to contact the hull of the vessel and to move relative to the hull, the cleaning head including cleaning elements for removing at least a portion of biofouling on the hull, a cable connected to the cleaning head and coupled to a winch for connecting the cleaning head to the vessel, a pulley system including sheave assembly disposed at or near the bow and through which the cable is routed, from the cleaning head, through the pulley system, and to the winch, and a control system in communication with the cleaning head. The method includes deploying the cleaning head along the hull of vessel while the vessel is underway, controlling movement of the cleaning head along the hull as the cleaning elements clean the hull, and controlling the winch to pay out and retract the cable based on a location of the cleaning head along the hull.

The movement of the cleaning head may be controlled by identifying an uncleaned area of the hull and directing the cleaning head to the uncleaned area.

### BRIEF DESCRIPTION OF THE DRAWINGS

Embodiments of the present invention will be described, by way of example, with reference to the drawings and to the following description, in which:

FIG. 1 is a schematic diagram of a hull cleaning system tethered to a hull of a vessel in accordance with an aspect of an embodiment;

FIG. 2 is a schematic diagram of a portion of the hull cleaning system of FIG. 1;

FIG. 3 is a perspective view of a cleaning head of the hull cleaning system of FIG. 1;

FIG. 4 is a bottom view of the cleaning head of FIG. 3;

FIG. 5 is a perspective view of a pulley system of the hull cleaning system of FIG. 1; and

FIG. 6 is a flowchart showing a method of cleaning a hull of a vessel utilizing a cleaning system in accordance with another aspect of an embodiment.

### DETAILED DESCRIPTION

The present disclosure relates generally to a system for cleaning a hull of a vessel. The system includes a cleaning head configured to contact the hull of the vessel and to move relative to the hull, the cleaning head including cleaning elements for removing at least a portion of biofouling on the hull, a cable connected to the cleaning head and coupled to a winch for connecting the cleaning head to the vessel, a pulley system including a sheave system near the bow and between the cleaning head and the winch and through which the cable is routed, and a control system in communication with the cleaning head.

The hull cleaning system is therefore tethered to the vessel in that the cleaning head is tethered by the cable. The cable may also be referred to as an umbilical and may include a hose or hoses for transporting fluid, as well as wires for power and communications to the cleaning head and between the cleaning head and the control system. The cleaning system may be utilized for removing biofouling from the hull while the vessel is underway. In the present disclosure, a vessel is underway when the vessel is moving through water, or when there is movement of water against the vessel. For example, the vessel may be a platform or other structure standing, or floating, in a current of water.

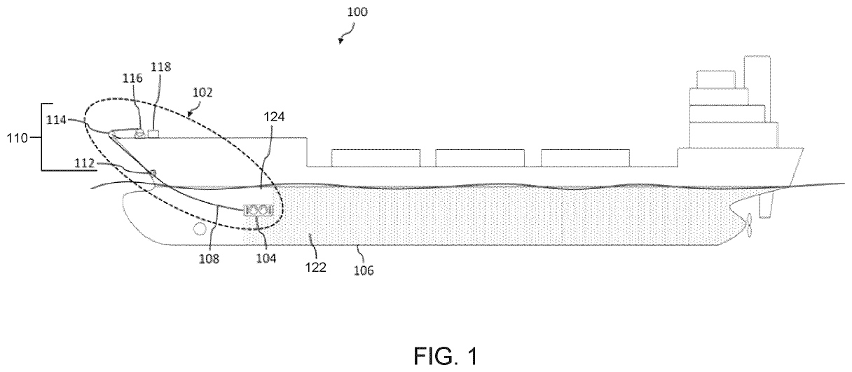

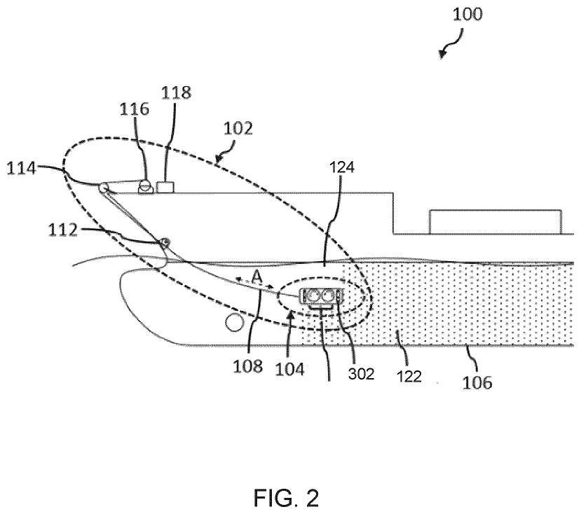

FIG. 1 and FIG. 2 are schematic diagrams illustrating a hull of a vessel 100 with a hull cleaning system 102 tethered to the hull. The hull cleaning system 102 includes the cleaning head 104 that is configured to contact the hull of the vessel 100 and to move relative to the hull. In the example of FIG. 1 and FIG. 2, the cleaning head 104 is in contact with and located on a surface of the hull 106.

A cable 108 is connected to the cleaning head 104 and coupled to a winch 116. The cable 108 mechanically couples the cleaning head 104 to the winch 116, and electrically couples the cleaning head 104 to a control system 118 for communication therebetween to control the cleaning head 104. In the present example, the control system 118 is disposed on a deck of the vessel 100. Alternatively, the control system 118 may be located elsewhere on or in the vessel 100 or may be partially disposed on the deck of the vessel 100 and partially disposed in another part of the vessel 100, such as on the bridge of the vessel 100.

The cable 108 is routed through a pulley system 110, which includes a bow sheave assembly disposed on the bow the vessel 100. The pulley system 110 facilitates redirection of the cable 108 that extends from the winch 116 on the deck of the vessel 100, through the pulley system 110, and to the cleaning head 104, which may be located anywhere along a side or bottom of the hull 106. The location of the cleaning head 104 relative to the hull 106 changes when the cleaning head 104 is utilized to clean the hull 106.

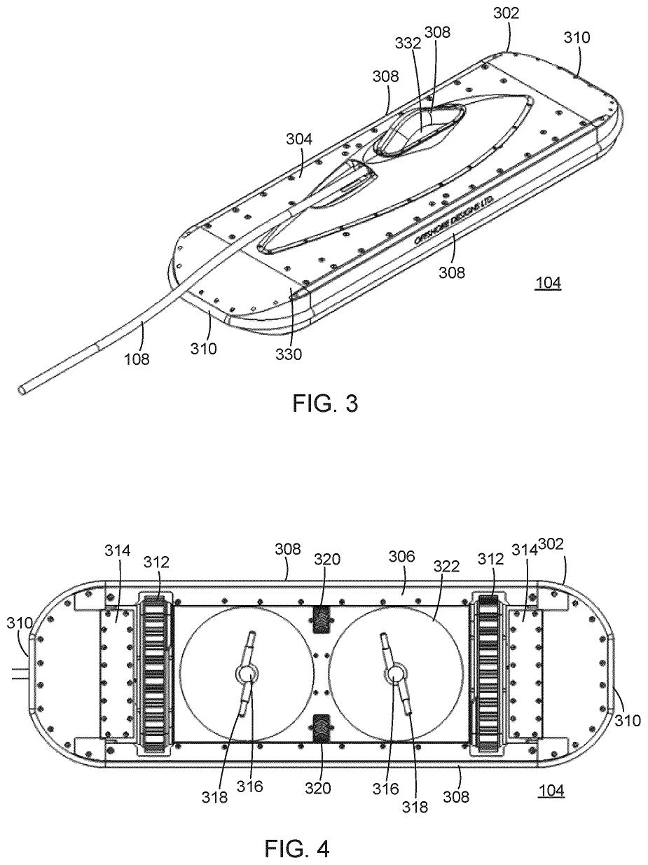

Reference is made to FIG. 3 and FIG. 4 which show the cleaning head 104 coupled to the cable 108 of the hull cleaning system of FIG. 1 and FIG. 2. The cleaning head 104 includes a body 302 that has an outer surface 304, an inner surface 306. The inner surface 306 is generally rectangular in shape with rounded corners. Thus, the body 302 has long sides 308, and short sides 310 that extend between the outer surface 304 and the inner surface 306. The inner surface 306 of the body 302 is in contact with the surface of the hull 106 of the vessel 100 when the cleaning head 104 is in use. The outer surface 304 is shaped to maintain contact of the cleaning head 104 with the hull 106 of the vessel 100 while the vessel 100 is underway. Thus, the outer surface 304 is shaped to reduce the chance that water movement relative to the hull 106 causes the cleaning head 104 to move off or be peeled away from the hull 106 while the vessel 100 is underway. The outer surface 304 may shaped to cause the water movement relative to the hull 106 to force the cleaning head 104 toward the surface of the hull 106, thus facilitating maintaining contact of the inner surface 306 with the hull 106. The outer surface may include hydrodynamic elements to create a force on the cleaning head to facilitate navigation along the hull, to maintain contact between the cleaning head and the hull, or both.

The inner surface 306 includes continuous tracks 312 that are exposed on the inner surface 306 of the body 302 for contacting with the surface of the hull 106. The continuous tracks 312 extend generally between the opposing long sides 308, and are generally parallel with the opposing short sides 310. The continuous tracks 312 are coupled to a motor or motors housed within the body 302 for driving the continuous tracks 312 separately to move the cleaning head 104 and control direction of movement of the cleaning head 104 relative to the hull 106.

In the example of FIG. 3 and FIG. 4, the continuous tracks 312 are generally equally spaced from a centre of the inner surface 306 of the body 302. Rather than continuous tracks 312, wheels, which may be magnetic, may be utilized and may be separately driven for moving the cleaning head 104 and controlling the direction of the movement. Alternatively still, the cleaning head may include one or more thrusters for propelling the cleaning head 104 and controlling direction of the movement. Water thrusters may be utilized, for example. In addition, hydrodynamic components such as hydrofoils, rudders, fins, or any combination thereof may be utilized. Such components may be utilized to create a force that acts on the cleaning head to facilitate navigation along the hull.

The cleaning head 104 also includes magnets 314 that in the example embodiment are generally adjacent to the continuous tracks 312, with each of the magnets 314 disposed between a respective one of the continuous tracks 312 and a respective short side 308. Each of the magnets 314 is an array or bank of permanent magnets that together are utilized to maintain the cleaning head 104 in contact with the surface of the hull 106 of the vessel 100. The magnets may be, for example, neodymium iron boron magnets. Alternatively or in addition, a pump may be utilized to create suction to maintain the cleaning head 104 in contact with the hull 106 of the vessel 100. Alternatively, wheels may be utilized rather than the continuous tracks. Such wheels may be magnetic and, optionally, further magnets or banks of magnets may be utilized.

The cleaning elements of the cleaning head 104 in the present example include two rotating cavitating waterjet assemblies 316. The rotating cavitating waterjet assemblies 316 are exposed on the inner surface 306 of the cleaning head 104, between the two continuous tracks 312. Each rotating cavitating waterjet assembly 316 includes a pair of cavitating waterjet nozzles 318 that rotate and expel water for cleaning the surface of the hull 106. Each cavitating waterjet assembly 316 includes a dome shroud 322 between the cavitating waterjet nozzles 318 and the remainder of the body 302 to protect the body 102 when in use.

Alternatively or additionally, the cleaning elements of the cleaning head 104 may include other waterjet nozzles, wipers, brushes, or rotating cleaning pads, or any other suitable cleaning element for removing biofouling from a surface of hull 106.

In the present embodiment, magnetic wheels 320 are also exposed on the inner surface 306 of the cleaning head 104. The magnetic wheels 320 further facilitate maintaining contact of the cleaning head 104 on the hull 106 of the vessel 100 while the vessel 100 is underway. The magnetic wheels 320 rotate with movement of the cleaning head 104 along the surface of the hull 106. The wheels 320 may be passive or may be powered or motorized. Alternatively, a track or a pair of tracks may be utilized rather than wheels.

Although not shown in the present example, the cleaning head 104 may include one or more pivot joints such that the cleaning head 104 is articulated to facilitate conformance of the cleaning head 104 to a shape of the surface of the hull 106.

As indicated above, the outer surface 304 is shaped to maintain contact of the cleaning head 104 with the hull 106 of the vessel 100 while the vessel 100 is underway. In particular, the outer surface 304 includes a hydrodynamic shroud 330 to reduce resistance to water movement relative to the hull 106 when the vessel 100 is underway. Thus, the hydrodynamic shroud 330 and the magnets 314 together facilitate contact of the cleaning head 104 with the hull 106 of the vessel 108 while the vessel 108 is underway.

The cable 108 is routed into the body 302, through the outer surface 304. In addition, a camera 332, or cameras, as well as an instrumentation system are both housed within a generally transparent covering 334. The transparent covering 334 is shaped to reduce hydrodynamic resistance. Alternatively, the camera or cameras and instrumentation system may be located at other locations on the body 302 such as near a front of the body 302, along one or both of the opposing short sides 308, facing a long side 310, which may be referred to as a back of the body 302 based on direction of travel, or installed in the underside of the body 302 facing the hull surface. Lights may also be included on the cleaning head 104. The camera 332 or cameras may capture live video and the control system 118 may be utilized to record the live video. Alternatively or in addition, the camera 332 or cameras may be utilized to capture still images and the control system 118 may be utilized to store the images. In addition, the control system 118 may record data from instrumentation aboard the cleaning head 104 for the purpose of hull inspection.

The cleaning head 104 may also include auxiliary systems used for navigation, controls, and hull inspection, for example proximity sensors, pressure sensors, sonar sensors, load cells, GPS equipment, cameras, ultrasonic sensors, scanners, lights, and any combination thereof.

The cable 108 includes electrical conductor cables or wires for providing electrical connection to the cleaning head 104 from the vessel 100. In addition, the cable 108 includes communication wires (e.g., twisted pairs of copper wire) for electronic communication with the control system 118 to control the cleaning head 104. The cable 108 also includes a water supply line for supplying water to the rotating cavitating waterjet assemblies 316. The cable 108 may also include pneumatic hoses, hydraulic hoses, or both.

The water supply line is advantageous in that the water may be pumped from on board the vessel 100 via the cable 108. Thus, a water pump is not required at the cleaning head 104 to feed the rotating cavitating waterjet assemblies 316. This decreases the size and weight of the cleaning head 104, decreasing power requirements for the cleaning head 104 by comparison to a cleaning head that includes a pump. The cable may be generally neutrally buoyant such that the cable does not sink but is only slightly buoyant such that the cable does not apply a strong upwards force on the cleaning head as a result of buoyancy.

The wires and hoses of the cable 108 are protected by an outer sheath that includes a steel or synthetic fiber such as such as Kevlar or Vectran sheath to provide strength, surrounded by a jacket such as a thermoplastic rubber. Alternatively more than one cable may be utilized and coupled to the cleaning head 104.

Referring again to FIG. 2, the cable 108, as indicated above, is routed through the pulley system 110, which includes a deck cable routing assembly 114. The cable 108 is wound around the winch 116, through the deck cable routing assembly 114, which includes a pulley or pulleys for directing the cable 108 downwardly from the deck of the vessel 100, through the bow sheave assembly 112, which redirects the cable 108 toward the location of the cleaning head 104 on the hull 106 for cleaning.

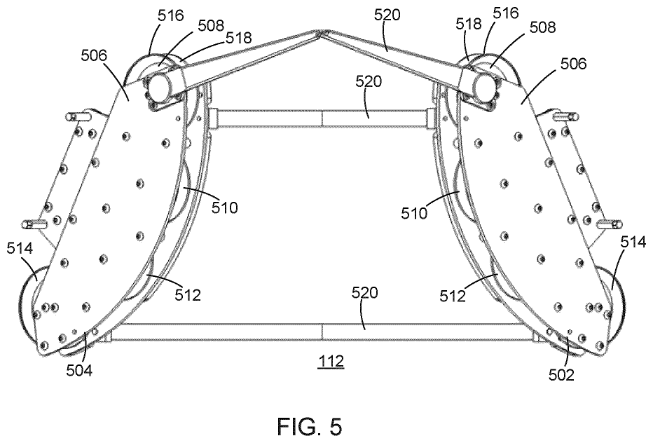

Reference is made to FIG. 5 to describe the bow sheave assembly 112 connected to the bow of the vessel 100 to facilitate routing of the cable 108 for cleaning the hull 106 of the vessel 100. The bow sheave assembly 112 includes two halves 502, 504 that are generally mirror images of each other. The two halves 502, 504 are configured to be fixed to the bow of the vessel 100. The bow sheave assembly 112 may be mechanically secured to the bow, for example, pinned, welded, bolted, bonded, or clamped to the bow. Alternatively, the bow sheave assembly 112 may be magnetically secured to the bow. Any combination of mechanical and magnetic securing may also be utilized.

Each half 502, 504 of the bow sheave assembly 112 includes a shell 506 in which a series of sheaves 508, 510, 512, 514 are mounted. In this example, the series of sheaves 508, 510, 512, 514 include four sheaves 508, 510, 512, 514, each mounted separately in the shell 506. Each of the sheaves 508, 510, 512, 514 includes a rim 516 defining the groove 518 of each sheave 508, 510, 512, 514. The rim width 516 is sized to receive the cable 108 in the groove of each of the sheaves 508, 510, 512, 514.

The shell 506 of one half 502 of the bow sheave assembly 112 is connected to the shell 506 of the other half 504 of the bow sheave assembly 112 by connecting arms 520. The connecting arms 520 extend across the bow of the vessel 100 such that each of the halves 502, 504 is disposed on a respective side, near the bow of the vessel 100 for directing or routing the cable 108 to the cleaning head 108 for cleaning the respective side of the hull of the vessel 100. The connecting arms 520 are mechanically coupled, for example, by welding or bolting to the shells 506. These connecting arms 520 maintain the cable between the two halves 502, 504 of the bow sheave assembly 112. By utilizing the connecting arms 520, the cable 108 is maintained in the bow sheave assembly 112 and inhibited from jumping off the sheaves.

The bow sheave assembly 112 is mounted above the waterline of the vessel in the present embodiment. Alternatively, the bow sheave assembly 112 may be mounted below the waterline of the vessel. The cable 108 is routed through the bow sheave assembly 112 such that the cable 108 is received in the grooves 518 of the sheaves 508 of the half 502, 504 of the bow sheave assembly 112 that is on the side of the hull being cleaned while underway. The bow sheave assembly 112 secures the cable 108 to the vessel 100 and directs the cable 108 that extends downwardly from the deck cable routing assembly 114, to the cleaning head 104 on the side of the hull 106.

In the example shown in FIG. 5, four sheaves 508, 510, 512, 514 are included in each shell 506. Other suitable numbers of sheaves, however, may be successfully implemented.

The pulley system 110, which includes the bow sheave assembly 112 and deck cable routing assembly 114 together facilitates redirection of the cable 108 that extends from the winch 116 on the deck of the vessel 100, to the cleaning head 104, which may be located anywhere along a side of the hull 106. The location of the cleaning head 104 relative to the hull 106 changes when the cleaning head is utilized to clean the hull 106. The pulley system may be also be located to facilitate movement of the cleaning head along a bottom of the hull 106.

The control system 118 is coupled to the winch 116 to control the length of the cable 108 that is paid out, which is dependent on the location of the cleaning head 104 along the hull 106 of the vessel 100. As the cleaning head 104 moves farther from the bow sheave assembly 112, more cable 108 is paid out by the winch 116. As the cleaning head 104 moves closer to the bow sheave assembly 112, the winch winds more cable 108 to reduce the length of the cable 108 that is paid out.

In addition to the control system 118, auxiliary equipment may be included on or in the vessel 100, for example, mounted on a deck, to support hull cleaning operation. Such auxiliary equipment may include a water compressor, and additional communications equipment.

The control system 118 communicates with the camera 332 as well as other instrumentation and auxiliary systems and, based on information received at the control system 118 from the camera 332 and optionally the instrumentation and auxiliary equipment, controls the operation of the cleaning head 104. Communication with the cleaning head 104 is via the cable 108. Alternatively, additional communications equipment as referred to above, may be utilized to support wireless communication with the cleaning head 104. The control system 118 controls the pump, the winch 116, and the cleaning head 104, including the continuous tracks 312, to control the movement of the cleaning head 104 and the cleaning operation.

In use, the hull cleaning system 102 is controlled to reduce biofouling on the hull 106 of the vessel 100 to which the hull cleaning system 102 is fixed. While the vessel 100 is underway, for example, at a speed of about 2 knots or greater, the hull cleaning system 100 is deployed for cleaning the hull 106 of the vessel. The control system 118 controls the cleaning head 104, the length of the cable 108 paid out utilizing the winch 116, and the operation of equipment such as the pump to control the rotating cavitating waterjet assemblies 316. The camera 332 as well as sensors and other equipment of the cleaning head 104 may be utilized for cleaning head navigation for guiding the movement of the cleaning head 104 during cleaning of the hull 106. In a particular example, the hull cleaning system 102 is used when the vessel is underway, for example, at a speed of about 2 knots or greater. The hull cleaning system 102 may be utilized while vessel is underway at a speed of about 6 knots or greater for a bulk carrier, or, for example, about 2 knots or greater for a barge.

The cleaning head 104 is tethered to the vessel 100 by the cable 108, which provides a mechanical tether, and is maintained in contact with the surface of the hull 106 of the vessel 100 even while the vessel is moving at, for example 6 to 8 knots or greater, by the shape of the hydrodynamic shroud and, optionally other hydrodynamic elements, as well as the magnet assemblies 316 and magnetic wheels 320.

Referring again to FIG. 1 and FIG. 2, the hull cleaning system 104 identifies an area 120 of the hull 106 that is not cleaned or includes biofouling, indicated by the dotted pattern in FIG. 1, and the control system 118 controls the cleaning head 104, winch 116, and other equipment such as the pump, and continues cleaning and advancing the cleaning head 104 to areas with biofouling. The area 122 of the hull that is cleaned is indicated by the numeral 124.

In the above description, the control system 118 includes hardware and software to control the movement of the cleaning head 104 relative to the hull 106. Alternatively, the cleaning head 104 may include hardware and software to control the movement relative to the hull 106.

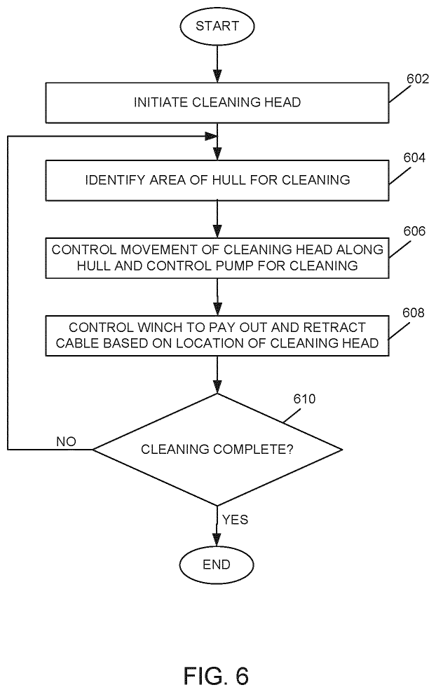

A flowchart illustrating a method of cleaning a hull of a vessel utilizing a cleaning system is shown in FIG. 6 and described with continued reference to FIG. 1 through 5. The method may include additional or fewer elements than shown and described and parts of the method may be performed in a different order than shown or described herein.

Cleaning is commenced at 602 and the cleaning head is initiated with the head disposed along the hull 106 while the vessel 100 is travelling through water, for example, at a speed of about 2 knots or greater. The cleaning may be utilized while vessel is underway at a speed of about 6 knots or greater for a bulk carrier, or, for example, about 2 knots or greater for a barge. The cleaning head may be deployed prior to commencing cleaning such that the cleaning head is located and ready for initiating on the side of the hull. Cleaning may be commenced at any time, for example, at a regular interval. Cleaning may begin by manually starting the system or may be programmatically controlled to clean.

An area of the hull for cleaning is identified at 604. The area of the hull for cleaning may be identified utilizing the camera 332 as well as sensors and other equipment of the cleaning head 104. Optionally, a map of the hull 106 may be utilized to identify and track areas that are cleaned and areas that are still to be cleaned.

Movement of the cleaning head 104 is then controlled at 606 and the pump is controlled to clean the part of the surface of the hull 106 that is in contact with the cleaning head 104. The movement of the cleaning head 104 may be controlled by navigation of the cleaning head 104 to areas to be cleaned. As the movement of the cleaning head 104 is controlled, the winch 116 is also controlled at 608 to pay out and retract the cable 108 based on the location of the cleaning head 104 and the travel of the cleaning head 104. Thus, the length of the cable 108 that is paid out is dependent on the location of the cleaning head 104 along the hull 106 to limit the length of cable 108 paid out and inhibit excess weight of cable 108 on the cleaning head 104.

When cleaning of the hull 106 is complete, the cleaning head 104 moves toward the bow of the vessel 100, the cable 108 is retracted, and the process ends. Otherwise the process continues and the movement of the cleaning head 104 along the hull 106 continues while cleaning the biofouling from the hull 106.

Advantageously, the hull cleaning system facilitates cleaning of the hull of a vessel while the vessel is underway. This allows cleaning of biofouling in deep water where invasive species, for example, cannot survive. Thus, the vessel is not required to be in port, docked, or anchored, where biofouling may contribute to the spread of invasive species, and where local port regulations may prevent such cleaning. In addition, cleaning is available as needed or desired, resulting in fuel savings for the vessel. Further, a vessel may be cleaned in deep water and arrive in port already clean.

1. A system for cleaning a hull of a vessel, the system comprising:
a cleaning head configured to contact the hull of the vessel and to move relative to the hull, the cleaning head including cleaning elements for removing at least a portion of biofouling on the hull;
a cable connected to the cleaning head and coupled to a winch for connecting the cleaning head to the vessel;
a pulley system including a sheave assembly between the cleaning head and the winch and through which the cable is routed; and
a control system in communication with the cleaning head.

2. The system according to claim 1, wherein the cable mechanically couples the cleaning head to the winch and electrically couples the cleaning head to the control system.

3. The system according to claim 1, wherein the cleaning elements comprise one or more of cavitating waterjets, waterjets, wipers, and brushes.

4. The system according to claim 1, wherein the winch is coupled to the control system for controlling a length of the cable that is paid out.

5. The system according to claim 1, wherein the winch is coupled to a deck of the vessel.

6. The system according to claim 1, wherein the pulley system includes a deck cable routing assembly.

7. The system according to claim 1, wherein the sheave assembly is disposed above a waterline of the vessel.

8. The system according to claim 2, wherein the control system controls the movement of the cleaning head relative to the hull.

9. The system according to claim 8, comprising a pump coupled to the cable for supplying water to the cleaning head.

10. The system according to claim 9, wherein the control system controls the pump supplying water to the cleaning head.

11. The system according to claim 1, comprising cameras onboard the cleaning head for capturing live video.

12. The system according to claim 11, wherein the control system is configured to record the live video.

13. The system according to claim 12, wherein the control system is configured to record data from instrumentation utilized for hull inspection.

14. The system according to claim 1, wherein the cleaning head includes software and hardware to control the movement of the cleaning head relative to the hull.

15. The system according to claim 1, wherein the cleaning head includes a thruster for moving the cleaning head relative to the hull.

16. The system according to claim 1, wherein the cleaning head includes a wheel or a track and a motor for driving the wheel or the track for moving the cleaning head relative to the hull.

17. The system according to claim 1, wherein the cleaning head includes one or more magnets for magnetically coupling the cleaning head to the hull.

18. The system according to claim 1, wherein the cleaning head includes one or more pumps for creating a suction force against the hull to maintain contact of the cleaning head with the hull.

19. Use of a system for cleaning a hull of a vessel while the vessel is underway, the system including:
a cleaning head configured to contact the hull of the vessel and to move relative to the hull, the cleaning head including cleaning elements for removing at least a portion of biofouling on the hull;
a cable connected to the cleaning head and coupled to a winch for connecting the cleaning head to the vessel;
a pulley system including sheave assembly disposed at or near the bow and through which the cable is routed, from the cleaning head, through the pulley system, and to the winch; and
a control system in communication with the cleaning head.

20. A method of cleaning a hull of a vessel utilizing a system comprising:
a cleaning head configured to contact the hull of the vessel and to move relative to the hull, the cleaning head including cleaning elements for removing at least a portion of biofouling on the hull;
a cable connected to the cleaning head and coupled to a winch for connecting the cleaning head to the vessel;
a pulley system including sheave assembly disposed at or near the bow and through which the cable is routed, from the cleaning head, through the pulley system, and to the winch; and
a control system in communication with the cleaning head,
the method comprising:
deploying the cleaning head along the hull of vessel while the vessel is underway;
controlling movement of the cleaning head along the hull as the cleaning elements clean the hull;
controlling the winch to pay out and retract the cable based on a location of the cleaning head along the hull.

21. The method according to claim 20, wherein controlling movement of the cleaning head comprises identifying an uncleaned area of the hull and directing the cleaning head to the uncleaned area.

22. The method according to claim 21, wherein the vessel is underway when the vessel is travelling at about 2 knots or greater.

23. The method according to claim 21, wherein the vessel is underway when the vessel is travelling at about 6 knots or greater.
